(19) United States
(12) Patent Application Publication
(10) Pub. No.: US 2022/0074230 A1
(43) Pub. Date: Mar. 10, 2022

(54) LOCK SYSTEM WITH ENHANCED KEYWAY VARIABILITY

(71) Applicants: MARC TOBIAS, PITTSBURGH, PA (US); TOBIAS BLUZMANIS, MIRAMAR, FL (US); ALEJANDRO OJEDA, ZURICH (CH)

(72) Inventors: MARC TOBIAS, PITTSBURGH, PA (US); TOBIAS BLUZMANIS, MIRAMAR, FL (US); ALEJANDRO OJEDA, ZURICH (CH)

(21) Appl. No.: 16/705,789

(22) Filed: Dec. 6, 2019

Related U.S. Application Data
(60) Provisional application No. 62/776,676, filed on Dec. 7, 2018.

(51) Int. Cl. E05B 19/00; E05B 19/04

(52) U.S. Cl. CPC E05B 19/007; E05B 19/0023; E05B 19/04

(57) ABSTRACT

A lock system may comprise a lock operating key for operating a lock, with the key including a bow and a blade extending from the bow along a longitudinal axis of the blade. The blade may include a blade wall with an arcuate main wall portion and a pair of side wall portions extending radially inward from opposite sides of the main wall portion. Bitting may be formed on the blade and be positioned on at least one of the side wall portions of the blade wall. The lock system may also include a lock plug defining a keyway having a transverse keyway profile configured to receive the blade of the key, with at least a portion of the keyway having an arcuate shape to receive the arcuate main wall portion of the blade wall of the key.

### REFERENCE TO RELATED APPLICATIONS

This application claims the priority of U.S. Provisional Patent Application No. 62/776,676, filed Dec. 7, 2018, which is hereby incorporated by reference in its entirety.

### BACKGROUND

### Field

The present disclosure relates to locks and more particularly pertains to a new lock system with enhanced keyway variability for increasing the range of possible keyway configurations to thereby increase the number of ways of differentiating keys usable in the same basic lock design.

### Description of the Prior Art

In general, there are at least three critical and distinct elements within a mechanical lock that can define its security, application-specific keying flexibility, and resistance to covert methods of entry. These elements are (1) the number of individual movable and critical locking components, (2) the tolerance between plug and shell at what is referred to as the shear line, and (3) the ability to create multiple keyways and corresponding warding of individual keys.

The first element, movable components, usually refers to pin tumblers or some form of rotating disc or slidable wafer. The number of movable components figures into the determination of the theoretical number of keys that can be anticipated and deployed for a given locking system. The tolerance at the shear line may also play a role in the determination of the actual number of unique key designs available for the locking system, and may also play a large role in the resistance of the locking system to different forms of covert attacks, including picking, impressioning, manipulation, decoding, and bumping.

### SUMMARY

In one aspect, the present disclosure relates to a lock system comprising a lock operating key for operating a lock, with the key including a bow and a blade extending from the bow along a longitudinal axis of the blade. The blade may include a blade wall with an arcuate main wall portion and a pair of side wall portions extending radially inward from opposite sides of the main wall portion. Bitting may be formed on the blade and be positioned on at least one of the side wall portions of the blade wall. The lock system may also include a lock plug defining a keyway having a transverse keyway profile configured to receive the blade of the key, with at least a portion of the keyway having an arcuate shape to receive the arcuate main wall portion of the blade wall of the key.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic perspective view of an illustrative lock operating key of a new lock system with enhanced keyway variability according to the present disclosure.

FIG. 2 is a schematic perspective end view of the illustrative key of the lock system, according to an illustrative embodiment.

FIG. 3 is a schematic end view of the illustrative key of the lock system, according to an illustrative embodiment.

FIG. 4A is a schematic cross-sectional view of the blade of an illustrative key taken transverse to the longitudinal axis of the blade with one illustrative blade profile, according to an illustrative embodiment.

FIG. 4B is a schematic cross-sectional view of the plug of a lock suitable for use with the key having the illustrative blade profile shown in FIG. 4A, according to an illustrative embodiment.

FIG. 5A is a schematic cross-sectional view of the blade of an illustrative key taken transverse to the longitudinal axis of the blade with another illustrative blade profile with a diminished vertical dimension as compared to the blade profile of the illustrative key of FIG. 4A, according to an illustrative embodiment.

FIG. 5B is a schematic cross-sectional view of the plug of a lock suitable for use with the key having the illustrative blade profile shown in FIG. 5A, according to an illustrative embodiment.

FIG. 6A is a schematic cross-sectional view of the blade of an illustrative key taken transverse to the longitudinal axis of the blade with another illustrative blade profile with a diminished horizontal dimension as compared to the blade profile of the illustrative key of FIG. 4A and optional bitting location, according to an illustrative embodiment.

FIG. 6B is a schematic cross-sectional view of the plug of a lock suitable for use with the key having the illustrative blade profile shown in FIG. 6A, according to an illustrative embodiment.

FIG. 7 is a schematic cross sectional view of the blade and bitting of an illustrative key generally corresponding to the key of FIG. 4A shown engaging illustrative movable tumbler elements of the lock, according to an illustrative embodiment

FIG. 8 is a schematic cross sectional view of the blade and bitting of an illustrative key generally corresponding to the key of FIG. 5A shown engaging illustrative movable tumbler elements of the lock, according to an illustrative embodiment

FIG. 9 is a schematic cross sectional view of the blade and bitting of an illustrative key generally corresponding to the key of FIG. 6A shown engaging illustrative movable tumbler elements of the lock, according to an illustrative embodiment

FIG. 10A is a schematic cross-sectional view of the blade of an illustrative key taken transverse to the longitudinal axis of the blade with one illustrative blade profile including an additional feature on the inner face of the main wall portion, according to an illustrative embodiment.

FIG. 10B is a schematic cross-sectional view of the plug of a lock suitable for use with the key having the illustrative blade profile shown in FIG. 10A, according to an illustrative embodiment.

FIG. 11A is a schematic cross-sectional view of the blade of an illustrative key taken transverse to the longitudinal axis of the blade with one illustrative blade profile including an additional feature on the inner face of the main wall portion, according to an illustrative embodiment.

FIG. 11B is a schematic cross-sectional view of the plug of a lock suitable for use with the key having the illustrative blade profile shown in FIG. 11A, according to an illustrative embodiment.

### DETAILED DESCRIPTION

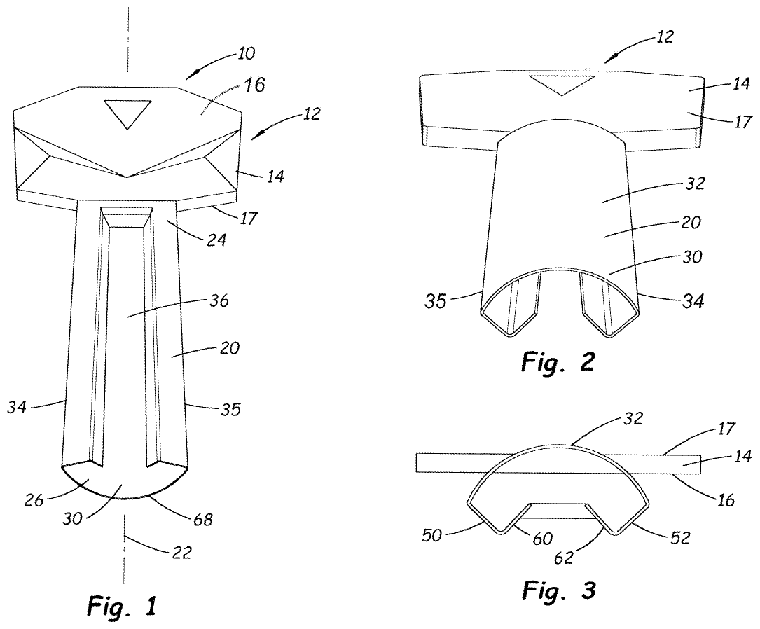

With reference now to the drawings, and in particular to FIGS. 1 through 11 thereof, a new lock system with enhanced keyway variability embodying the principles and concepts of the disclosed subject matter will be described.

The applicants have recognized that the greater the number of different characteristics that may be varied on a lock system, the greater the number of unique theoretical combinations of those characteristics that may be incorporated into the key design to provide unique keys that may be utilized with the lock system, and potentially increases the security provided by the locking system. Besides unique keying, the number of additional options may be expanded, such as the provision of multiple levels of master keys, Maison-key arrangements, as well as minimizing the opportunity for the unintentional sharing of common key configurations between the locking systems of different buildings, facilities, organizations, etc.

The applicants understand that, for a locking system to be accepted as a secure mechanism, lock manufacturers often desire to offer a lock and key design in combinations that provide the capability of utilizing multiple keyway characteristics in the same lock system. For example, the pattern of warding utilized in the keyway of a lock design is one characteristic that can be varied. In general, the keyway of a mechanical lock is a primary security element for the lock because it can prevent the introduction and insertion of unauthorized keys or keys that are designed for other systems. In other words, a keyway is a form of gatekeeper in that it can prevent keys designed for other lock systems from even entering the lock and engaging movable elements of the lock, such as the internal tumblers, and thereby making it impossible for such keys to open the lock. Perhaps more importantly, the ability to utilize different keyways within the same lock system creates the capability of vastly increasing the potential number of different combination of lock characteristics for any particular lock, since every unique keyway multiplies the overall number of combinations of characteristics.

The applicants also appreciate that differences in keyway designs within a lock system can also make it difficult or impossible to duplicate keys by locksmiths, unauthorized users, or criminals. Lock manufacturers may create different keyways, especially for high security lock systems, to provide and create unique geographic territories or user levels for specific locksmiths, dealers, or corporate and government clients, as a few examples. As such, the ability to vary the keyway design can be critical to the security as well as commercial success for any lock system that portends to offer any level of security.

The applicants have recognized that various approaches to high-security locks have been proposed, with the approach disclosed in U.S. Pat. No. 9,920,548 to Ojeda Gonzalez-Posada et al. (which is hereby incorporated by reference) being one example of a high-security key and lock. However, while the '548 patent describes a unique key and plug with a design likely to make it difficult to compromise, particularly by visually decoding the lock, the applicants of this disclosure also recognize that the design may also have some limitations which may inhibit its security and thus its commercial acceptance. More specifically, the design of the key, keyway, and plug in the '548 patent does not allow for a range of additional and individual keyways to increase the number of possible combinations of different key characteristics, which is a result of the lack of the use of traditional warding patterns on the surface of the key and the keyway.

In this disclosure, the applicants describe a simple yet effective approach to significantly add to the number of usable ways of differentiating keys for use on the same locking system. The disclosure describes a lock system using a keyway with an arcuate transverse profile which is different from the round keyway common in many cylindrically-shaped axial pin tumbler locks. The key utilized with this lock system does not rely upon an in-line or linear configuration for the keyway, which is the traditional means of creating keyways and associated warding.

In the disclosed lock system, different characteristics for the arcuate transverse profile of the key and keyway may be used to effectively block the introduction of unauthorized keys that are intended for different lock systems, and may permit the creation of a more complex keying system that would not otherwise be available on lock systems employing only one invariable set of keyway design characteristics. As a result of the variability of the keyway characteristics, insertion of a key into the plug of a particular lock can be restricted by the specific characteristics of the keyway. Creating variability in these keyway design characteristics is facilitated by the use of the arcuate transverse shape of the keyway, and the blade of the key, rather than a circular transverse shape or other closed shape. The magnitude of at least one of the characteristics, such as the lateral width and the lateral height, of the transverse keyway profile of the keyway may be variable between lock plugs such that the keyway is able to receive only keys with transverse blade profiles compatible with the lateral width and the lateral height of the keyway profile of the keyway.

The disclosure generally relates to a lock system 10 in which enhanced variability of various characteristics of the operating key are made possible, and in particular the variability of the keyway and corresponding operating key configured to enter the keyway. In general, a lock has a keyway into which a key is inserted to operate the lock if the key is properly configured to operate the particular lock.

In one aspect of the disclosure, a lock operating key 12 is provided for operating the lock of the lock system 10. The key 12 may have a bow 14 for being gripped by the fingers of a user when using the key to operate the lock. The bow 14 typically has a front face 16 and a rear face 17 which may be oriented generally parallel to each other to provide opposite pinching or gripping surfaces on the key when being held by the user.

The key 12 may also have a blade 20 which extends from the bow 14 for insertion into the keyway or key slot of the lock. The blade 20 may be elongated along a longitudinal axis 22 which extends in an axial direction of the key and the lock into which the key is insertable. The blade may have a base end 24 unified with the bow 14, as well as a free end 26 which is located opposite of the bow 14 and which is initially insertable into the keyway. For point of reference, a first plane may be oriented substantially perpendicular to the longitudinal axis 22 of the blade, and a second plane may be oriented substantially parallel to the longitudinal axis and also be oriented substantially parallel to one or both of the faces 16, 17 of the bow 14.

The blade 20 may include a blade wall 30 which may include a plurality of blade wall portions which may form a transverse blade profile in a plane oriented parallel to the first plane, e.g., oriented perpendicular to the longitudinal axis 22 of the blade. The blade wall portions may include a main wall portion 32 which may have a pair of sides 34, 35 which are located on substantially opposite sides of the main wall portion and which extend substantially parallel to the longitudinal axis 22 of the blade. The main wall portion 32 may have an inner face 36, and may also have a lateral extent 38 along an arc that terminates at the opposite sides 34, 35 of the main wall portion, and as such the lateral extent may not be circular or form a complete circle. The main wall portion 32 may be arcuate in shape in the transverse blade profile, and the arcuate character of the main wall portion may extend from the free end 26 of the blade toward the base end 24 in a substantially uniform manner between the ends. In some embodiments, the arcuate lateral extent may be defined by a section of a circle, and may be characterized by an angle 40 and a radius 42 defined relative to a center of curvature point 44. The radius 42 may be measured from the center of curvature point 44 to the main wall portion, such as the inner face 36 of the portion 32. The angle 40 may be measured with respect to the center of curvature point 44 as well, and may be measured between the sides 34, 35 of the main wall portion. In other embodiments, the arcuate lateral extent may be defined by sections of other geometric shapes. In some embodiments, sections of shapes which are non-circular and do not have a uniform radius about a common point may be used to define the shape of the arcuate lateral extent of the main wall portion, and such shapes may include, for example, oval, elliptical, etc. Illustratively, the arcuate shape of the main wall portion may be characterized as a concave leak curved section

The blade wall 30 may also include a pair of side wall portions 50, 52 which extend along the main wall portion 32, with each of the side wall portions being located along one of the sides 34, 35 of the main wall portion and extending radially inward with respect to the curvature of the main wall portion. The side wall portions may be separated by a gap such that the blade of the key (or the wall portions of the blade) does not form a complete circle. The side wall portions may extend generally from the free end 26 of the blade towards the base end 24. Each of the side wall portions may have an inner surface 54 which may be positioned in some degree of opposition to the inner face 36 of the main wall portion. The side wall portions 50, 52 may each be substantially linear and planar in the transverse blade profile plane. A plane containing the inner surface 54 may be oriented at an angle to the inner face 36 of the main wall portion at the point of intersection between the respective side wall portion and the main wall portion. In some embodiments, the angle is a substantially perpendicular angle, although a range of angles may be utilized including, for example, between approximately 45 degrees and approximately 135 degrees.

The blade wall 30 may also include a pair of return wall portions 60, 62 which each extend along a respective side wall portion, and may also extend from the respective side wall portion toward each other to effectively form a channel with the side wall portions and the main wall portion. The return wall portions may be oriented substantially perpendicular to the sidewall portions, although in other embodiments the return wall portions may be oriented at angles with respect to the side wall portions that are somewhat larger or smaller than 90 degrees. The return wall portions may also extend in an orientation that is substantially equidistant from the interface of the main wall portion such that the return wall portions are substantially parallel to sections of the main wall portion. Each of the return wall portions 60, 62 may extend from the free end 26 of the blade toward the base end 24. Each of the return wall portions 60, 62 may have a return wall edge 64, 66 which may be substantially linear in straight from the free end of the blade toward the base end.

The blade wall 30 may also include a tip edge 68 with a section of the tip edge being formed on the main wall portion. The tip edge 68 may be configured to assist with guidance of the tip of the key into the keyway. For example, the tip edge 68 may be tapered in width in a lateral direction oriented perpendicular to the longitudinal axis 22 of the blade. Illustratively, the tip edge 68 may be arcuate in shape when viewed in a plane parallel to the second plane.

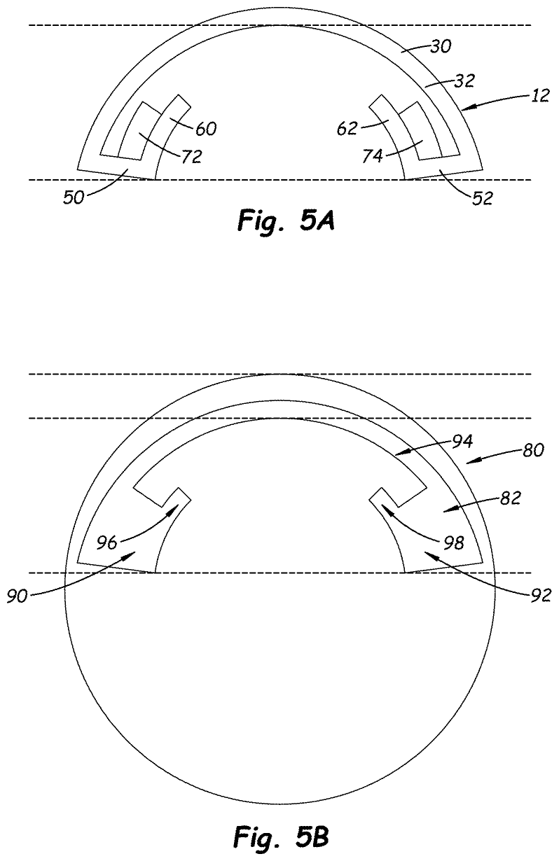

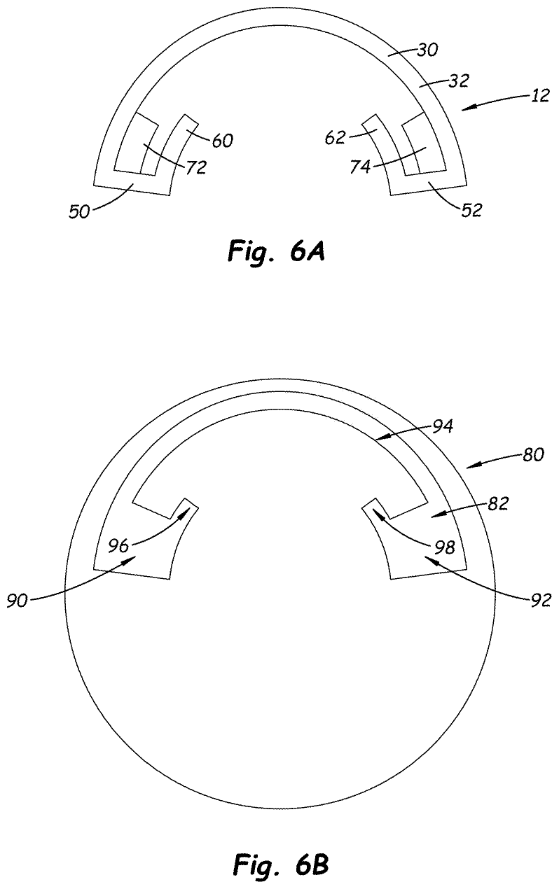

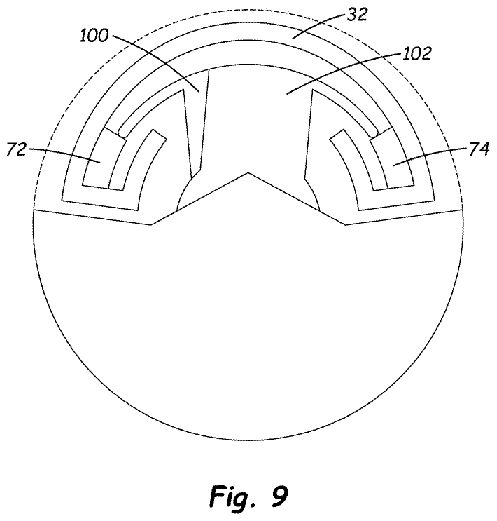

The blade 20 may also include bitting 70 configured to interact with movable elements of the lock which engage the bitting when the key 12 is inserted into the keyway. The bitting 70 may be formed on the key at a variety of locations on the key, such as on surfaces and/or on edges of the key, and may be formed on the blade wall 30. The bitting may be located on at least one of the side wall portions 50, 52, and more preferably may be located on both of the side wall portions. The bitting may further be located on the inner surface of one or both of the side wall portions. Illustratively, the bitting 70 may be positioned adjacent to the respective return wall portion 60, 62 (see, e.g., FIGS. 5A and 8), or may be positioned adjacent to the main wall portion 32, or optionally in some combination of positions adjacent to the return wall and main wall portions (see, e.g., FIGS. 6A and 9).

In general, the bitting 70 may comprise any surface features suitable to interact and cause movement of movable elements of the lock. In some embodiments, the bitting 70 may include at least one protrusion 72 protruding from a surface of one of the wall portions, and may include more than one protrusion 72, 74 which are positioned adjacent to opposite lateral sides of the main wall portion. Optionally, other types of surface characteristics such as grooves or dimples may also be employed to provide the bitting.

Significantly, the formation of the bitting 70 on some surfaces of the key, such as the illustrative inner surface 54 of the side wall portions, produces bitting patterns and characteristics that are not readily viewable to the eye of someone holding the key, which complicates attempts to compromise the lock system through duplication of the key by concealing the specific bitting pattern of the key.

The lock system 10 may also include a lock plug 80 for mounting in a shell or housing to rotate with respect to the shell to operate a locking element. The lock plug 80 may define a keyway 82 which extends in an axial direction of the plug and which may have a transverse keyway profile 84 in a plane oriented perpendicular to the axial axis along which a key moves during insertion of the key into the keyway. The transverse keyway profile 84 may have various characteristics, such as, for example, a transverse width 86 and a transverse height 87. The magnitude of characteristics of the transverse keyway profile, such as the magnitude of the transverse width and the transverse height, may be varied to block the blades of keys with incompatible transverse blade profiles from entering the keyway and engage any bitting on the key with tumbler elements of the lock plug, and accept insertion of only keys having compatible blade profiles. As lock plugs are typically readily interchangeable between compatible lock shells, the ability to produce variations in the keyway profiles in different lock plugs which are compatible with a common shell design facilitates the ability to vary the keyways (and compatible keys) between locks, and as a result effectively block keys from being inserted into the keyways of lock plugs with incompatible profiles.

In greater detail, the transverse keyway profile may have a pair of lobe portions 90, 92 which are connected by a linking portion 94. The linking portion 94 may be configured to receive the main wall portion 32 of the blade wall 30 of the blade of the operating key when inserted into the keyway. Each lobe portion 90, 92 may be configured to receive sections of the main wall portion, the side wall portion, and the return wall portion of the blade wall of the inserted operating key. The lobe portions 90, 92 may be laterally spaced from each other, and the linking portion 94 may have an arcuate shape in the transverse keyway profile 84. The linking portion 94 may have a relatively thin thickness in the keyway profile 84 in comparison to the thicker or wider lobe portions 90, 92. The transverse keyway profile may also include a pair of return portions 96, 98 extending from the lobe portions 90, 92 generally toward each other in the keyway. Each return portion 96, 98 may be configured to receive a section of one of the return wall portions 60, 62 of the blade wall of the inserted operating key. The return portions 96, 98 of the profile 84 may each extend at substantially uniform spacings from the linking portion 94, and each return portion may have an arcuate shape in the transverse keyway profile.

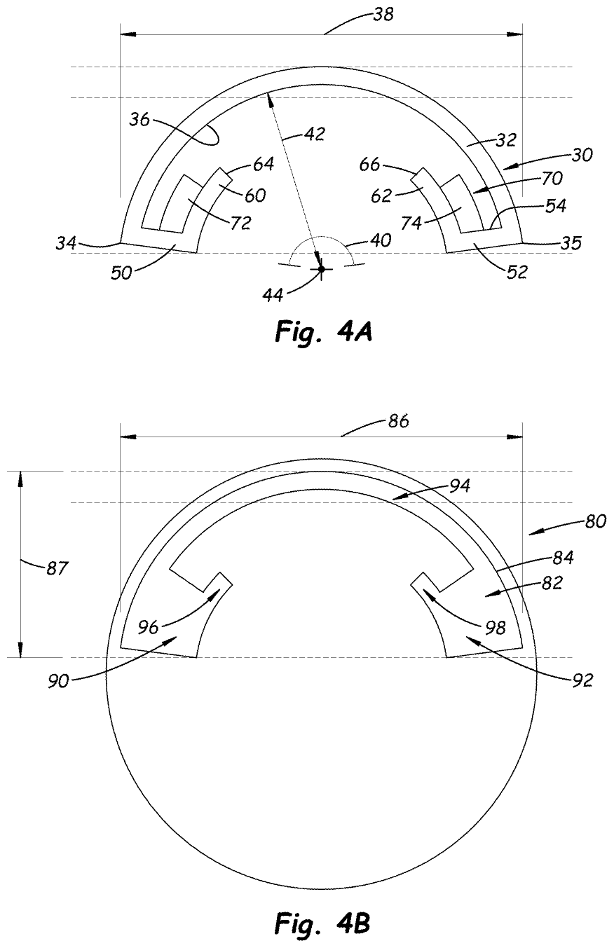

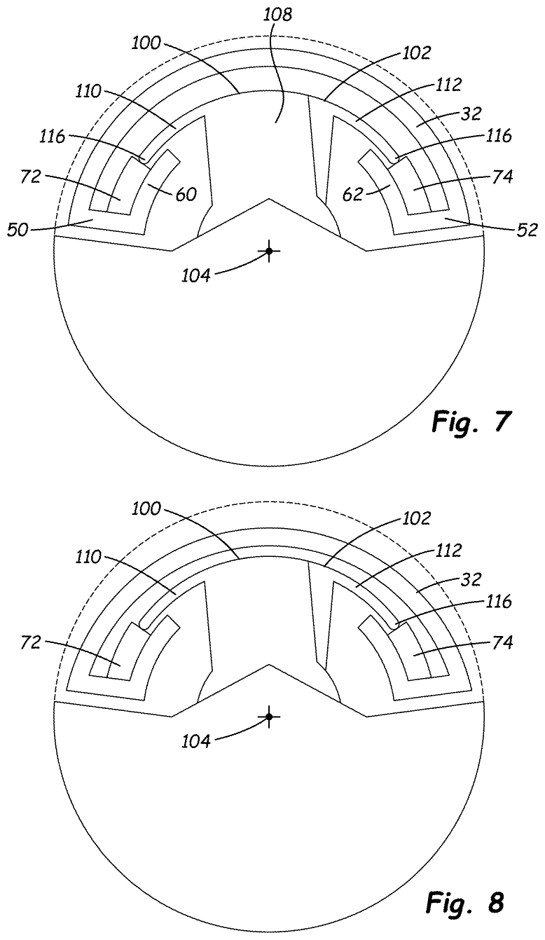

Significantly, various characteristics of the key and the keyway may be varied to produce variations in the keys and keyways. For example, in some embodiments the arc of the main wall portion 32 of the key blade and of the corresponding linking portion 94 of the keyway may be formed by a section of a circle, such as illustrated in FIGS. 4A, 4B and 7 of the drawings. In other embodiments, the dimension of the arc of the main wall portion and corresponding linking portion may be diminished or compressed in the transverse height, such as illustrated in FIGS. 5A, 5B and 8. In still other embodiments, the dimension of the arc of the main wall portion and corresponding linking portion may be diminished or compressed in the transverse with, such as illustrated in FIGS. 6A, 6B and 9.

The lock system 10 may further include a plurality of tumbler elements 100, 102 movably mounted on the lock plug 80. At least a portion of each of the tumbler elements may have a position adjacent to the keyway 82 of the plug, and suitably the portions of the tumbler elements may be positioned in the keyway. The tumbler elements 100, 102 may be arranged in an array extending along a portion of the extent of the keyway 82. In some embodiments, the tumbler elements may be rotatable with respect to the plug 80, and may be rotatable independently of each other about a rotation axis 104. Illustratively, each of the tumbler elements 100, 102 may include a central portion 108 which extends generally radially outward with respect to the rotation axis 104, and at least one contact portion 110, 112 for engaging bitting on the blade of the operating key when the key is inserted into the keyway of the lock plug such that the bitting is able to move or rotate the tumbler elements about the rotation axis. For each tumbler, the contact portion may extend from the central portion 108, and the contact portions of the individual tumbler elements may extend in substantially opposite directions from the central portions of the respective elements. The contact portion or portions may be arcuate to extend adjacent to or along a portion of the main wall portion 32 of the blade wall when the key is inserted into the keyway. Each of the contact portions may have a contact tip 116 which is configured to engage the bitting 70, such as the protrusions 72, 74 on the side wall portions. The contact portions may extend between the main wall portion 32 and one of the return wall portions to engage the protrusions on the side wall portions of the blade wall.

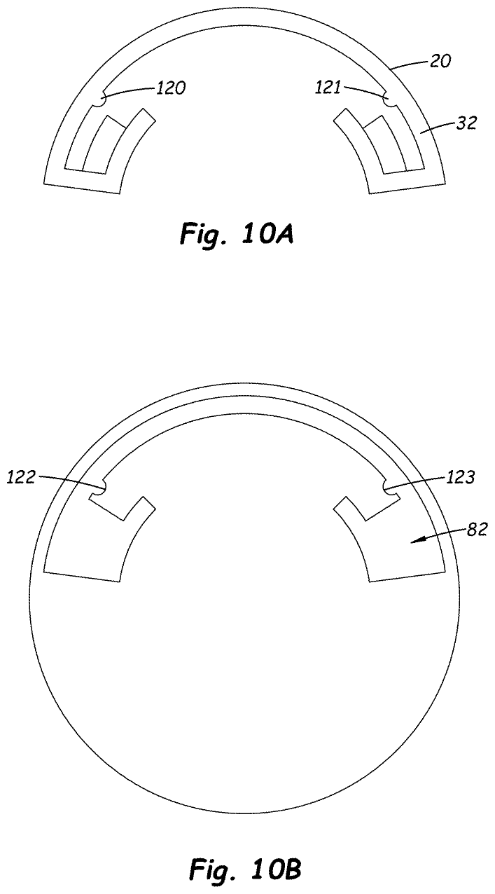

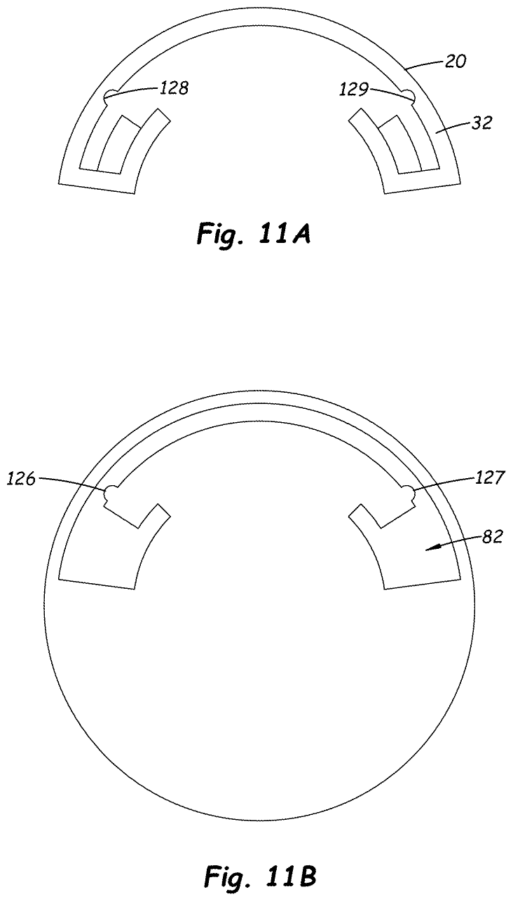

Additional security features may be utilized on the lock system, and in particular with respect to the interaction of the key blade 20 and the keyway 82. For example, additional protrusions 120, 121 may be provided on the key blade with corresponding grooves being formed in the keyway that are configured to accept or accommodate the protrusions (as illustratively shown in FIGS. 10A and 10B) when the key blade is inserted into the keyway to add further complication to the key and keyway to enhance security. The additional protrusions 120, 121 may be positioned on the inner face 36 of the main wall portion at a location that is difficult to view by someone seeking to compromise the lock system. As another example, additional protrusions 126, 127 may be formed on the keyway with corresponding grooves being formed in the key blade that are configured to accept or accommodate the protrusions (as illustratively shown in FIGS. 11A and 11B). The protrusions and grooves may extend in an axial direction of the key and the keyway of the lock, and in some embodiments, the axial extent of the protrusions and/or grooves in an axial direction may be less than the axial extent of the features forming the bitting 70 in the axial direction

It should be recognized that formation of the key using more conventional key-producing techniques may be frustrated by the unique configuration features of the disclosure, which may as a result enhance the security of the lock system from being compromised. Keys may be made in any suitable manner, such as, for example, additive manufacturing processes known colloquially as 3-D printing which utilize material deposition in a serial manner to build up the material into the desired key configuration.

It should be appreciated that in the foregoing description and appended claims, that the terms “substantially” and “approximately,” when used to modify another term, mean “for the most part” or “being largely but not wholly or completely that which is specified” by the modified term.

It should also be appreciated from the foregoing description that, except when mutually exclusive, the features of the various embodiments described herein may be combined with features of other embodiments as desired while remaining within the intended scope of the disclosure.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

With respect to the above description then, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that fall within the scope of the claims.

We claim:

1. A lock system comprising:
a lock operating key for operating a lock, the key having a transverse blade profile in a transverse plane oriented substantially perpendicular to the longitudinal axis of the blade, the key comprising:
a bow;
a blade extending from the bow along a longitudinal axis of the blade, the blade including a blade wall with an arcuate main wall portion and a pair of side wall portions, the main wall portion being arcuate in shape in the transverse blade profile, each of the side wall portions extending inward from one of the opposite sides of the main wall portion and generally toward an other one of the opposite sides of the main wall portion;
bitting formed on the blade, the bitting being positioned on at least one of the side wall portions of the blade wall;
a lock plug defining a keyway having a transverse keyway profile configured to receive the blade of the key, at least a portion of the transverse keyway profile having an arcuate shape to receive the arcuate main wall portion of the blade wall of the key.

2. The system of claim 1 wherein each of the side wall portions extends inwardly from one of the opposite sides of the arcuate main wall portion in a substantially perpendicular relationship to the main wall portion at the one side of the main wall portion.

3. The system of claim 1 wherein the blade additionally includes a pair of return wall portions with each return wall portion extending from one of the side wall portions in an orientation substantially equidistant to portions of the main wall portion.

4. The system of claim 3 wherein the bitting on at least one of the side wall portions of the blade wall is positioned adjacent to at least one of the return wall portions of the blade wall.

5. The system of claim 1 wherein the side wall portions of the key are separated by a gap such that the blade of the key does not form a complete circle.

6. The system of claim 1 wherein each of the side wall portions of the blade wall has an inner surface, and the bitting is located on the inner surface of at least one of the side wall portions of the blade wall.

7. The system of claim 1 wherein a first one of the transverse blade profile and the transverse keyway profile has a protrusion and a second one of the transverse blade profile and the transverse keyway profile has a groove in a position configured to accept the protrusion when the blade of the key is inserted into the keyway of the lock plug.

8. The system of claim 7 wherein the protrusion and the groove extend in an axial direction of the key and lock plug, and an axial extent of the protrusion and the groove is less than an axial extent of the bitting formed on the blade of the key.

9. The system of claim 1 wherein the bitting formed on the blade on both of the side wall portions of the blade wall.

10. The system of claim 1 additionally comprising at least one tumbler element movably mounted on the lock plug and configured to engage the bitting on the blade of the key when the key is inserted into the keyway of the plug.

11. The system of claim 10 wherein the at least one tumbler element is rotatable with respect to a rotation axis on the lock plug, the at least one tumbler element including:
a central portion extending generally radially outward with respect to the rotation axis; and
at least one contact portion for engaging bitting on the blade of the lock operating key when the operating key is inserted into the keyway of the lock plug such that the bitting is able to rotate the at least one tumbler element about the rotation axis, the at least one contact portion extending from the central portion.

12. The system of claim 11 wherein the at least one contact portion comprising a pair of contact portions extending in substantially opposite directions from the central portion, the contact portion being arcuate to extend along a portion of the main wall portion of the blade wall when the key is inserted into the keyway.

13. The system of claim 1 further comprising:
a second key including a second blade; and
a second lock plug defining a second keyway having a second transverse keyway profile configured to receive the second blade, the second blade including a second arcuate main wall portion having a curvature different from the main wall portion of the first key, the second transverse keyway profile having a second portion having an arcuate shape having a curvature different from the arcuate shape of the first transverse keyway profile.

14. The system of claim 1 wherein the main wall portion of the blade of the key has a lateral extent along an arc in the transverse plane, the lateral extent being defined by an angle and a radius; and
wherein a magnitude of the angle and a magnitude of the radius are compatible with a lateral width and a lateral height of the transverse keyway profile of the keyway of the lock plug.

15. The system of claim 1 wherein the transverse keyway profile has a pair of lobe portions connected by a linking portion, the linking portion being configured to receive the main wall portion of the blade wall of the blade of the operating key, each lobe portion being configured to receive sections of the main wall portion, the side wall portion, and the return wall portion of the blade wall of the blade of the operating key.

16. The system of claim 1 wherein the arcuate shape of the main wall portion of the blade wall in the transverse blade profile is noncircular; and
wherein a portion of the arcuate shape of the transverse keyway profile of the lock plug configured to receive the main wall portion of the blade wall is noncircular.

17. The system of claim 16 wherein the arcuate shape of the main wall portion in the transverse blade profile is a concavely curved section; and
wherein the portion of the arcuate shape of the transverse keyway profile of the lock plug is a concavely curved section.

18. The system of claim 17 wherein the concavely curved section of the arcuate shape of the main wall portion is oval or elliptical; and
wherein the concavely curved section of the arcuate shape of the transverse keyway profile of the lock plug is oval or elliptical.

19. The system of claim 1 wherein the lock plug has a circular periphery and the arcuate shape of the transverse keyway profile has a first end portion and a second end portion with a middle portion arranged between the first and second end portions, the arcuate shape being compressed in a transverse height with respect to the circular periphery such that first and second end portions are arranged closer to the circular periphery than the middle portion.

20. The system of claim 1 wherein the lock plug has a circular periphery and the arcuate shape of the transverse keyway profile has a first end portion and a second end portion with a middle portion arranged between the first and second end portions, the arcuate shape being compressed in a transverse width with respect to the circular periphery such that the middle portion is arranged closer to the circular periphery than the first and second end portions

21. The system of claim 1 wherein the lock plug has a periphery and all portions of the keyway are spaced away from the periphery of the plug.
